(19) United States
(12) Patent Application Publication
(10) Pub. No.: US 2026/0210837 A1
(43) Pub. Date: Jul. 23, 2026

(54) DETERIORATION DETERMINATION DEVICE AND DETERIORATION DETERMINATION METHOD

(71) Applicant: Mitsubishi Electric Corporation, Chiyoda-ku, Tokyo (JP)

(72) Inventor: Shohei NISHIMURA, Chiyoda-ku, Tokyo (JP)

(73) Assignee: Mitsubishi Electric Corporation, Chiyoda-ku, Tokyo (JP)

(21) Appl. No.: 19/134,865

(22) PCT Filed: Apr. 3, 2023
(86) PCT No.: PCT/JP2023/013857

§ 371 Date: Jun. 2, 2025

(51) Int. Cl. G01N 17/00

(52) U.S. Cl. CPC G01N 17/006

(57) ABSTRACT

A deterioration determination device includes a corroded amount acquirer, a concentration estimator, and a deterioration determiner. The corroded amount acquirer acquires a thickness reduction of a thin metal film, mounted on any of substrates of an electronic apparatus in a railway vehicle and is made of a metal material corroded due to a corrosive gas, within an estimation period from the start of operation of the railway vehicle. The concentration estimator estimates a concentration of the corrosive gas around the railway vehicle, based on the thickness reduction of the thin metal film within the estimation period and a relationship between the concentration of the corrosive gas and a change over time in the thickness of the metal material. The deterioration determiner determines whether any sign of deterioration exists in the substrates of the electronic apparatus, based on the length of the estimation period and the estimated concentration.

### TECHNICAL FIELD

The present disclosure relates to a deterioration determination device and a deterioration determination method.

### BACKGROUND ART

Control apparatuses for controlling in-vehicle devices installed in railway vehicles each include multiple substrates provided with various control circuits. The control apparatus may be disposed in an environment, such as under the floor or on the roof of the vehicle body, exposed to corrosive gases that can corrode the metals forming the wiring patterns of the substrates. Such corrosion of metals is detected by some detection devices, an example of which is disclosed in Patent Literature 1, to avoid malfunctions of the control apparatus. The corrosion monitoring device disclosed in Patent Literature 1 includes sensors that include bare copper patterns and determine whether the patterns are broken due to corrosion.

The corrosion monitoring device disclosed in Patent Literature 1 detects breakage of the bare copper patterns included in the sensors due to corrosion. The corrosion monitoring device can thus detect deterioration of the substrates before occurrence of corrosion of wiring patterns covered with a solder mask and a coating material.

### CITATION LIST

### Patent Literature

Patent Literature 1: Unexamined Japanese Patent Application Publication No. 2001-358429

### SUMMARY OF INVENTION

### Technical Problem

In order to detect a sign of corrosion with high accuracy before occurrence of corrosion of wiring patterns, a device preferably detects a concentration of a corrosive gas, because the concentration of the corrosive gas affects the rate of corrosion of a metal by the corrosive gas. The concentration of the corrosive gas cannot be detected by the corrosion monitoring device disclosed in Patent Literature 1, which is designed to detect breakage of the bare copper patterns that precedes occurrence of corrosion of the wiring patterns.

An objective of the present disclosure, which has been accomplished in view of the above situations, is to provide a deterioration determination device and a deterioration determination method that can estimate a concentration of a corrosive gas and thus determine whether any sign of deterioration exists in substrates with high accuracy.

### Solution to Problem

In order to achieve the above objective, a deterioration determination device according to the present disclosure includes a corroded amount acquirer, a concentration estimator, and a deterioration determiner. The corroded amount acquirer acquires a reduction in the thickness of a thin metal film, mounted on any of substrates included in an electronic apparatus installed in a railway vehicle and is made of a metal material corroded due to exposure to a corrosive gas, within an estimation period from the time of start of operation of the railway vehicle. The concentration estimator estimates a concentration of the corrosive gas around the railway vehicle, based on the reduction in the thickness of the thin metal film within the estimation period acquired by the corroded amount acquirer and a relationship between the concentration of the corrosive gas and a change over time in the thickness of the metal material. The deterioration determiner determines whether any sign of deterioration exists in the substrates included in the electronic apparatus, based on the length of the estimation period and the concentration of the corrosive gas estimated by the concentration estimator.

Advantageous Effects of Invention A deterioration determination device according to the present disclosure estimates a concentration of the corrosive gas. The deterioration determination device can determine whether any sign of deterioration exists in the substrates included in the electronic apparatus on the basis of the length of the estimation period and the concentration of the corrosive gas, thereby achieving highly accurate determination of the existence of a sign of deterioration in the substrates.

### BRIEF DESCRIPTION OF DRAWINGS

FIG. 1 is a block diagram illustrating a deterioration determination device according to Embodiment 1;

FIG. 2 is an exploded perspective view of an electronic apparatus including substrates to be subject to determination by the deterioration determination device according to Embodiment 1;

FIG. 3 illustrates an exemplary manner of implementation of the deterioration determination device according to Embodiment 1;

FIG. 4 illustrates a hardware configuration of the deterioration determination device according to Embodiment 1;

FIG. 5 is a flowchart illustrating exemplary steps of a process of determining a sign of deterioration executed by the deterioration determination device according to Embodiment 1;

FIG. 6 illustrates an exemplary concentration of a corrosive gas and an exemplary change over time in the thickness of a metal material in Embodiment 1;

FIG. 7 illustrates an exemplary monitoring device that outputs a result of determination by the deterioration determination device according to Embodiment 1;

FIG. 8 illustrates an exemplary manner of implementation of a deterioration determination device according to Embodiment 2; and

FIG. 9 illustrates a modification of a hardware configuration of a deterioration determination device according to the embodiments.

### DESCRIPTION OF EMBODIMENTS

The following describes a deterioration determination device and a deterioration determination method according to embodiments of the disclosure in detail with reference to the accompanying drawings. In the drawings, the components identical or corresponding to each other are provided with the same reference symbol.

### Embodiment 1

A typical example of an electronic apparatus including substrates provided with wiring patterns is a control apparatus for controlling in-vehicle devices installed in a railway vehicle. For example, the control apparatus controls a power conversion apparatus that converts fed electric power into another electric power to be fed to a motor and feeds the converted electric power to the motor. The control apparatus is disposed at a site exposed to the ambient air, for example, under the floor or on the roof of the railway vehicle.

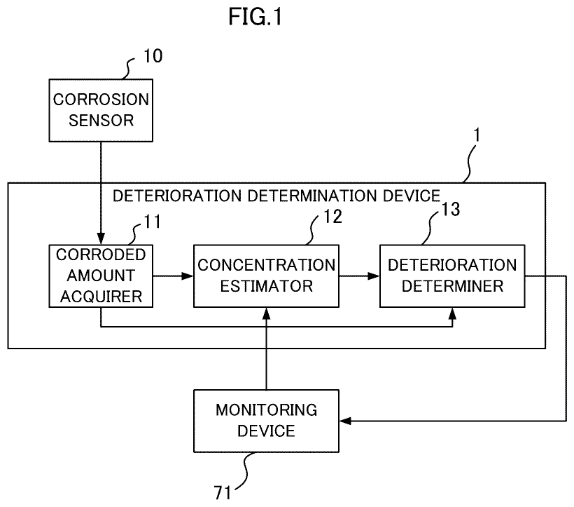

When the ambient air contains a corrosive gas that can corrode metals, the ambient air may corrode the wiring patterns mounted on the substrates included in the control apparatus disposed at the site exposed to the ambient air. Such corrosion of the wiring patterns and other deterioration in the substrates may cause malfunctions of the control apparatus. In order to avoid this problem, a deterioration determination device 1 according to Embodiment 1 illustrated in FIG. 1 determines whether the control apparatus shows any sign of deterioration.

The deterioration determination device 1 includes a corroded amount acquirer 11 to acquire a reduction in the thickness of a thin metal film within an estimation period on the basis of the value measured by a corrosion sensor 10 mounted on one of the substrates included in the control apparatus, a concentration estimator 12 to estimate a concentration of a corrosive gas around the railway vehicle on the basis of the reduction in the thickness of the thin metal film, and a deterioration determiner 13 to determine whether any sign of deterioration exists in the substrates on the basis of the length of the estimation period and the concentration of the corrosive gas. The deterioration determination device 1 outputs a result of the determination by the deterioration determiner 13, to a monitoring device 71 installed in a cab, for example.

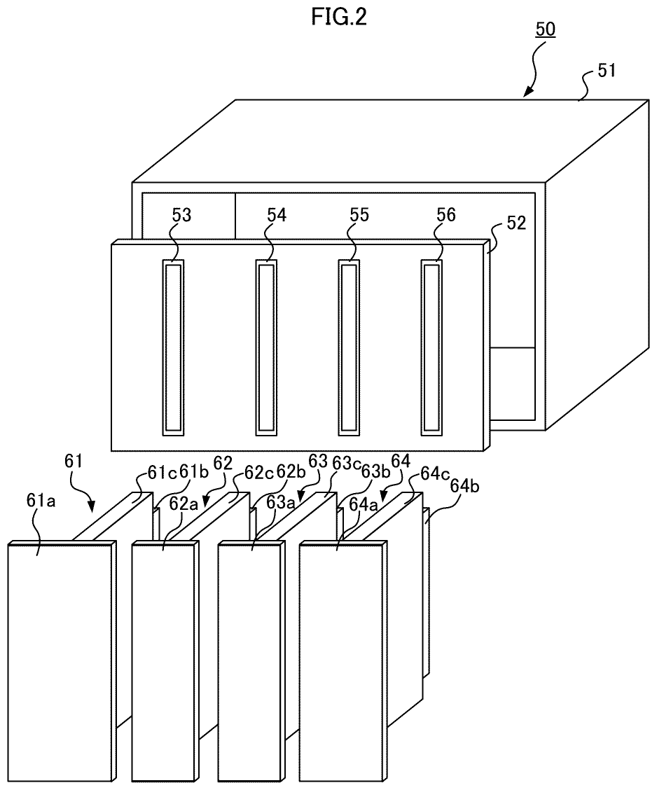

FIG. 2 illustrates an exemplary control apparatus for which the deterioration determination device 1 determines whether any sign of deterioration exists. A control apparatus 50 includes a subrack 51 to be fixed under the floor of the railway vehicle with fixing members, which are not illustrated, and a backplane 52 accommodated in the subrack 51. The subrack 51 has a box shape having an opening on one surface. The backplane 52 has slots 53, 54, 55, and 56. The slots 53, 54, 55, and 56 are connected to each other via power source lines and signal lines, which are not illustrated, for example.

The control apparatus 50 further includes plug-in units 61, 62, 63, and 64 connected to the respective slots 53, 54, 55, and 56. The plug-in units 61, 62, 63, and 64 include front panels 61a, 62a, 63a, and 64a connected to cables, which are not illustrated, connectors 61b, 62b, 63b, and 64b inserted in the respective slots 53, 54, 55, and 56, and substrates 61c, 62c, 63c, and 64c provided with electronic circuits.

The deterioration determination device 1 preferably determines whether any sign of deterioration exists in the substrates 62c, 63c, and 64c, on the basis of the value measured by the corrosion sensor 10 mounted on the substrate of one of the plug-in units 61, 62, 63, and 64 located at the end in the direction of arrangement of the plug-in units 61, 62, 63, and 64, for example, the substrate 61c of the plug-in unit 61. The substrate 61c is provided for the purpose of deterioration determination, and the other substrates 62c, 63c, and 64c are provided with control circuits for controlling in-vehicle devices.

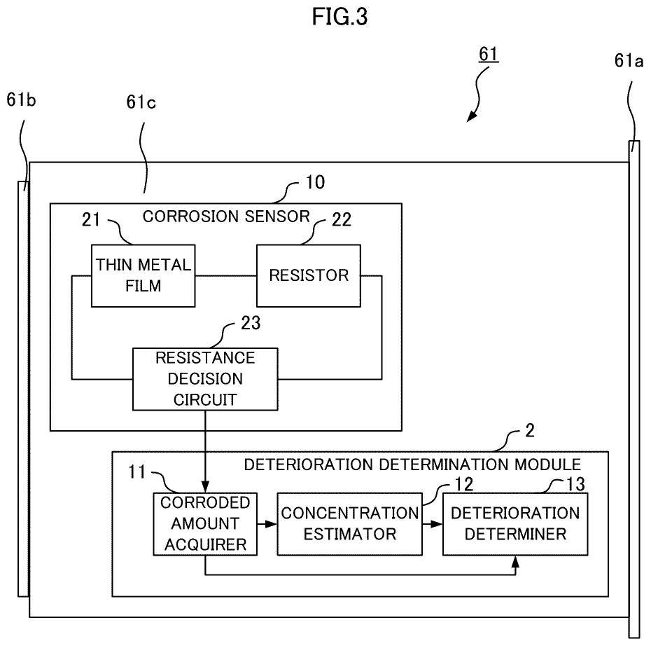

The deterioration determination device 1 is achieved by a deterioration determination module 2 mounted on the substrate 61c, as illustrated in FIG. 3. The corrosion sensor 10 is also mounted on the substrate 61c. The corrosion sensor 10 includes a thin metal film 21 provided on the substrate 61c, a resistor 22 connected in series to the thin metal film 21 on the substrate 61c, and a resistance decision circuit 23 that acquires a combined resistance of the thin metal film 21 and the resistor 22.

The thin metal film 21 is made of a metal material, such as silver, susceptible to corrosion due to exposure to a corrosive gas, such as hydrogen sulfide. The thickness of the thin metal film 21 is smaller than the thickness of the metal material forming the wiring patterns mounted on the substrates 62c, 63c, and 64c of the other plug-in units 62, 63, and 64, specifically, the thickness of the silver coatings. The thickness of the thin metal film 21 is 100 nm, for example.

The resistor 22 is made of a material more resistant to the corrosive gas than the thin metal film 21, for example, a copper material having a surface plated with tin or nickel.

The resistance decision circuit 23 includes a power source, such as constant current source. The resistance decision circuit 23 causes current to flow in the circuit including the thin metal film 21 and the resistor 22 connected in series to each other, and calculates a combined resistance of the thin metal film 21 and the resistor 22 on the basis of the voltage applied to the circuit and the current flowing in the circuit. The resistance decision circuit 23 outputs the calculated combined resistance to the corroded amount acquirer 11.

In the case where the region around the factory that manufactures the railway vehicle and the running region in which the railway vehicle actually runs have significantly different concentrations of the corrosive gas, the existence of a sign of deterioration in the substrates 62c, 63c, and 64c is preferably determined based on the concentration of the corrosive gas after transport of the railway vehicle to the running region. The corroded amount acquirer 11 thus acquires a reduction in the thickness of the thin metal film 21 within an estimation period starting from the time of start of operation of the railway vehicle. The time of start of operation of the railway vehicle indicates the time of manipulating a switch for an operation start instruction installed in the cab after transport of the railway vehicle from the factory to the running region, for example. The corroded amount acquirer 11, when receiving an operation start signal indicating an operation start instruction output in response to a manipulation of this switch, defines the time of reception of the operation start signal as the time of start of the estimation period. The corroded amount acquirer 11 measures a length of the period from the time of reception of the operation start signal to the current time, and outputs the measured length, in the form of the length of the estimation period, to the concentration estimator 12 and the deterioration determiner 13.

The corroded amount acquirer 11 estimates a thickness of the thin metal film 21 on the basis of the combined resistance of the thin metal film 21 and the resistor 22, which varies depending on the cross-sectional area of the thin metal film 21, acquired from the resistance decision circuit 23. The corroded amount acquirer 11 calculates a reduction in the thickness of the thin metal film 21 within the estimation period. The reduction in the thickness is equal to the difference between the original thickness of the thin metal film 21 and the thickness of the thin metal film 21 estimated from the combined resistance. The corroded amount acquirer 11 preliminarily retains information on the original thickness of the thin metal film 21.

The concentration estimator 12 estimates a concentration of the corrosive gas around the railway vehicle, on the basis of the reduction in the thickness of the thin metal film 21 within the estimation period acquired from the corroded amount acquirer 11, and the relationship between the concentration of the corrosive gas and a change over time in the thickness of the metal material constituting the thin metal film 21. The concentration estimator 12 outputs the estimated concentration of the corrosive gas to the deterioration determiner 13.

The deterioration determiner 13 determines whether any sign of deterioration exists in the substrates 62c, 63c, and 64c, on the basis of the length of the estimation period acquired by the corroded amount acquirer 11 and the concentration of the corrosive gas estimated by the concentration estimator 12. In detail, the deterioration determiner 13 determines whether any sign of deterioration exists in the substrates 62c, 63c, and 64c, on the basis of the thickness of the metal material forming the wiring patterns mounted on the substrates 62c, 63c, and 64c, the length of the estimation period acquired by the corroded amount acquirer 11, and the concentration of the corrosive gas estimated by the concentration estimator 12. The deterioration determiner 13 outputs a result of the determination to the monitoring device 71 illustrated in FIG. 1.

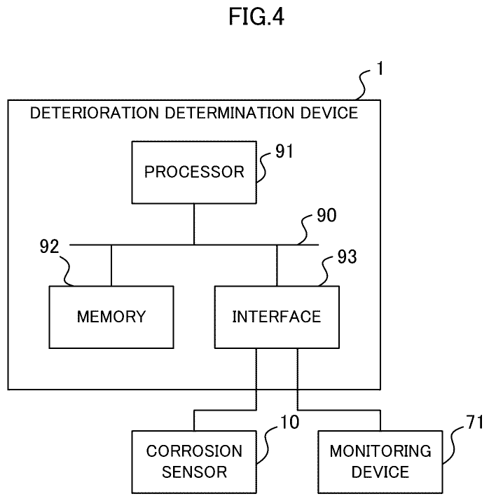

FIG. 4 illustrates a hardware configuration of the deterioration determination device 1 having the above-described configuration. The deterioration determination device 1 includes a processor 91, a memory 92, and an interface 93. The processor 91, the memory 92, and the interface 93 are connected to each other via buses 90. The functions of the components of the deterioration determination device 1 are implemented by software, firmware, or a combination of software and firmware. The software and firmware are described in the form of programs, and stored in the memory 92. The processor 91 reads and executes the programs stored in the memory 92 to implement the functions of the above components. That is, the memory 92 stores programs for the processes of the components of the deterioration determination device 1.

The memory 92 is, for example, a non-volatile or volatile semiconductor memory such as a random access memory (RAM), a read-only memory (ROM), a flash memory, an erasable programmable read-only memory (EPROM), or an electrically erasable and programmable read-only memory (EEPROM), or a magnetic disk, a flexible disk, an optical disk, a compact disc, a mini disc, or a digital versatile disc (DVD).

The deterioration determination device 1 is connected to the corrosion sensor 10 and the monitoring device 71 via the interface 93. The interface 93 includes an interface module complying with one or more standards as appropriate for connection targets.

The deterioration determination device 1 is implemented by providing the substrate 61c with a microprocessor including the processor 91, the memory 92, and the interface 93.

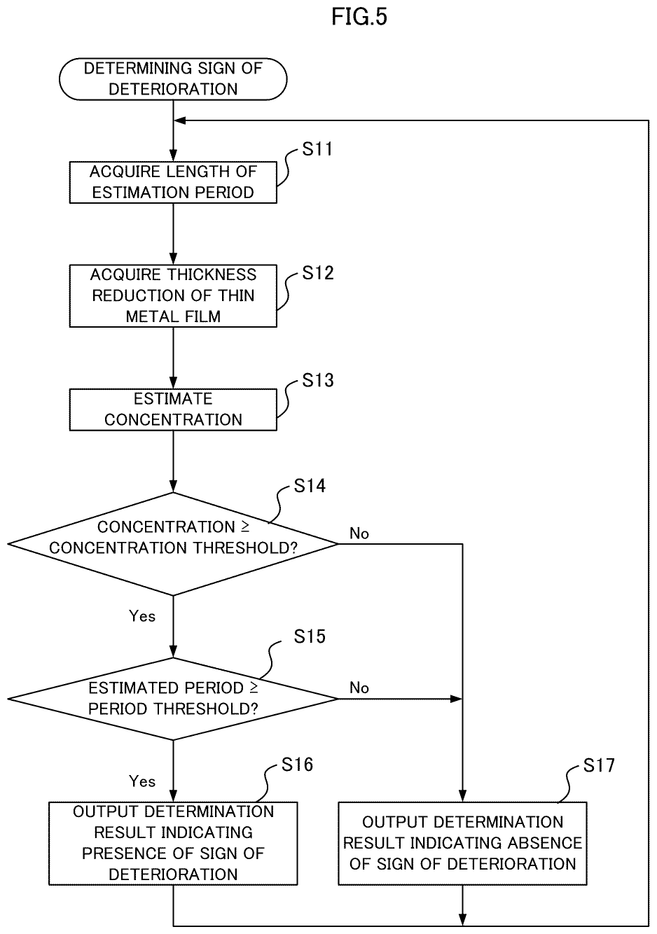

The deterioration determination device 1 having the above-described configuration executes a process of determining a sign of deterioration illustrated in FIG. 5 during the operation of the railway vehicle. For example, the deterioration determination device 1 initiates the process of determining a sign of deterioration illustrated in FIG. 5, when the deterioration determination device 1 receives electric power from a current collector via a power source device, which is not illustrated, after electrical connection of the current collector to a power supply line caused by a manipulation of an activation switch installed in the cab.

The corroded amount acquirer 11 first acquires a length of the estimation period that indicates a length of the period from the time of reception of an operation start signal to the current time (Step S11). In detail, the corroded amount acquirer 11 retains the time of reception of the operation start signal indicating an operation start instruction, in the form of the time of start of the estimation period. The corroded amount acquirer 11 acquires the length of the estimation period from the time of start of the estimation period to the current time, for example, by means of an internal timer of the central processing unit (CPU), which is an example of the processor 91.

The corroded amount acquirer 11 acquires the combined resistance of the thin metal film 21 and the resistor 22 from the corrosion sensor 10, and acquires, from the combined resistance, a reduction in the thickness of the thin metal film 21 within the estimation period (Step S12). The corroded amount acquirer 11 outputs the length of the estimation period acquired in Step S11 to the concentration estimator 12 and the deterioration determiner 13, and outputs the reduction in the thickness of the thin metal film 21 acquired in Step S12 to the concentration estimator 12.

When the thin metal film 21 is broken, the circuit including the broken thin metal film 21 and the resistor 22 does not conduct current, and thus results in a sudden increase in the combined resistance of the thin metal film 21 and the resistor 22 calculated by the resistance decision circuit 23. The corroded amount acquirer 11 therefore deems the reduction in the thickness of the thin metal film 21 to be equal to the original thickness of the thin metal film 21 when the combined resistance acquired from the resistance decision circuit 23 becomes equal to or higher than a resistance threshold.

The resistance threshold is defined to be higher than the upper limit of possible combined resistances during current flow in the circuit including the thin metal film 21 and the resistor 22.

In Embodiment 1, the corroded amount acquirer 11 outputs the length of the period from the time of reception of the operation start signal indicating an operation start instruction to the time when the combined resistance becomes equal to or higher than the resistance threshold, in the form of the length of the estimation period, to the concentration estimator 12 and the deterioration determiner 13. The corroded amount acquirer 11 also outputs the original thickness of the thin metal film 21, in the form of the reduction in the thickness of the thin metal film 21 within the estimation period, to the concentration estimator 12. The corroded amount acquirer 11 preliminarily retains information on the original thickness of the thin metal film 21.

The concentration estimator 12 estimates a concentration of the corrosive gas around the railway vehicle, on the basis of the reduction in the thickness of the thin metal film 21 within the estimation period, and a relationship between the concentration of the corrosive gas and the change over time in the thickness of the metal material forming the thin metal film 21 (Step S13). The concentration estimator 12 outputs the estimated concentration of the corrosive gas to the deterioration determiner 13.

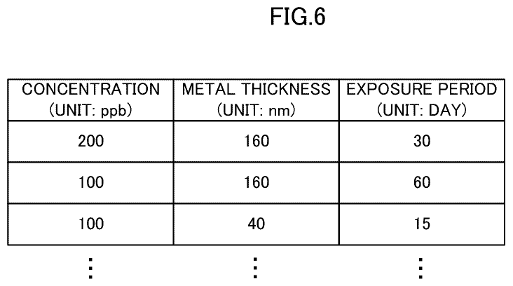

The concentration estimator 12 preliminarily retains a relationship between the concentration of the corrosive gas and the change over time in the thickness of the metal material constituting the thin metal film 21, an example which is illustrated in FIG. 6. FIG. 6 illustrates a relationship among the concentration of hydrogen sulfide, which is an example of the corrosive gas, the original thickness of silver, which is an example of metals that can be corroded by hydrogen sulfide, and the exposure period. The exposure period indicates the time needed for the reduction in the thickness of silver exposed to hydrogen sulfide to reach the original thickness. The exposure period corresponds to the time needed for occurrence of breakage of silver exposed to hydrogen sulfide. The concentration is expressed in parts per billion (ppb), the thickness of the metal material is expressed in nanometers (nm), and the exposure period is expressed in days.

Specifically, the data in the first row of FIG. 6 indicates that the exposure of silver having a thickness of 160 nm to hydrogen sulfide at a concentration of 200 ppb leads to breakage of silver in 30 days. The relationship between the concentration of the corrosive gas and the change over time in the thickness of the metal material forming the thin metal film 21 illustrated in FIG. 6 is preliminarily obtained through examinations or simulations of exposure of a metal to the corrosive gas, for example.

The concentration estimator 12 estimates a concentration of an ambient corrosive gas, by applying the length of the estimation period and the reduction in the thickness of the thin metal film 21 to the relationship illustrated in FIG. 6. In an exemplary case where the original thickness of the thin metal film 21 is 160 nm and the estimation period, from the time of reception of the operation start signal indicating an operation start instruction to the time when the combined resistance becomes equal to or higher than the resistance threshold, is 80 days, the concentration estimator 12 estimates the concentration of the corrosive gas to be 100 ppb. In another exemplary case where the original thickness of the thin metal film 21 is 160 nm and the estimation period is 60 days, the concentration estimator 12 estimates the concentration of the corrosive gas to be 150 ppb.

The deterioration determiner 13 determines whether any sign of deterioration exists in the substrates 62c, 63c, and 64c, on the basis of the length of the estimation period acquired in Step S11 in FIG. 5 and the concentration of the corrosive gas estimated in Step S13. In detail, the deterioration determiner 13 determines whether the concentration of the corrosive gas is at least a concentration threshold (Step S14). The concentration threshold is defined in accordance with the thickness of the metal material forming the wiring patterns mounted on the substrates 62c, 63c, and 64c, and the relationship between the concentration of the corrosive gas and the change over time in the thickness of the metal material forming the wiring patterns. The concentration threshold indicates a concentration of the corrosive gas that can corrode the wiring patterns during the operation of the railway vehicle over several decades. The deterioration determiner 13 preliminarily retains information on the concentration threshold.

When the concentration of the corrosive gas is lower than the concentration threshold (Step S14; No), the deterioration determiner 13 outputs a result of determination indicating the absence of any sign of deterioration, to the monitoring device 71 (Step S17). After completion of Step S17, Step S11 and the following steps are repeated.

In contrast, when the concentration of the corrosive gas is equal to or higher than the concentration threshold (Step S14; Yes), the deterioration determiner 13 determines whether the estimation period is at least a period threshold (Step S15). The period threshold is a threshold varying depending on the concentration of the corrosive gas, and is defined in accordance with the rate of corrosion of the metal material forming the wiring patterns mounted on the substrates 62c, 63c, and 64c due to exposure to the corrosive gas. In detail, the period threshold is defined in accordance with the thickness of the metal material forming the wiring patterns mounted on the substrates 62c, 63c, and 64c, and the rate of corrosion of the metal material varying depending on the concentration of the corrosive gas.

The rate of corrosion is calculated from the relationship between the concentration of the corrosive gas and the change over time in the thickness of the metal material forming the thin metal film 21 illustrated in FIG. 6. The deterioration determiner 13 preliminarily retains information on the rate of corrosion of the metal material forming the wiring patterns mounted on the substrates 62c, 63c, and 64c. The following assumes an example in which the concentration of the corrosive gas is 200 ppb, the rate of corrosion is 160 nm per 30 days, and the thickness of the silver coating that forms the wiring patterns is 80 nm. In this example, the thickness of the silver coating is reduced by 80 nm in 15 days, thereby adversely affecting the functions of the control circuit. The deterioration determiner 13 in this example defines the period threshold to be 10 days shorter than 15 days, for example, and can thus detect any sign of deterioration in the substrates 62c, 63c, and 64c before malfunctions of the control circuit.

When the estimation period is shorter than the period threshold (Step S15; No), the deterioration determiner 13 outputs a result of determination indicating the absence of any sign of deterioration, to the monitoring device 71 (Step S17). After completion of Step S17, Step S11 and the following steps are repeated.

In contrast, when the concentration of the corrosive gas is equal to or higher than the concentration threshold and the estimation period is equal to or longer than the threshold period (Step S14; Yes, Step S15; Yes), the deterioration determiner 13 outputs a result of determination indicating the presence of any sign of deterioration, to the monitoring device 71 (Step S 16). After completion of Step S16, Step S11 and the following steps are repeated.

The deterioration determination device 1 repeats the above-described process every certain period, for example, every 200 milliseconds, during power supply from the power source device.

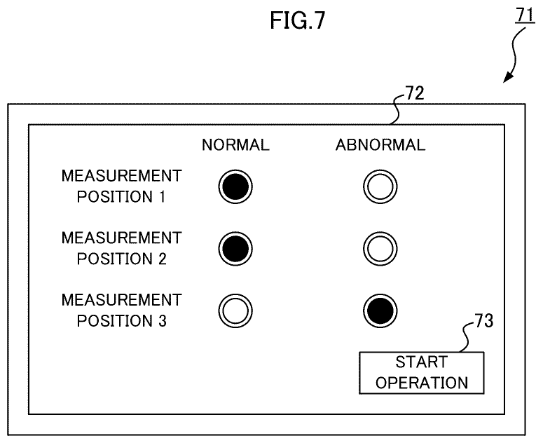

The monitoring device 71, when receiving the result of determination from the deterioration determiner 13 included in the deterioration determination device 1, causes the result of determination to be displayed on a display screen 72, as illustrated in FIG. 7. In the example illustrated in FIG. 7, the railway vehicle is provided with multiple deterioration determination devices 1. The deterioration determination devices 1 perform deterioration determination for mutually different subjects. The display screen 72 displays results of determination by the respective deterioration determination devices 1. The display screen 72 indicates the absence of any sign of deterioration as normal and the presence of any sign of deterioration as abnormal in the example illustrated in FIG. 7.

The display screen 72 is a touch panel and contains a button 73 thereon.

The button 73 serves as a switch for instructing the railway vehicle to start operation. A manipulation of the button 73 causes the operation start signal to be output to the deterioration determination device 1.

As described above, the deterioration determination device 1 according to Embodiment 1 estimates a concentration of the corrosive gas, and determines whether any sign of deterioration exists in the substrates 62c, 63c, and 64c included in the control apparatus 50 for controlling in-vehicle devices, on the basis of the length of the estimation period from the start of operation of the railway vehicle and the concentration of the corrosive gas. The determination based on the length of the estimation period and the concentration of the corrosive gas can achieve highly accurate detection of the existence of a sign of deterioration in the substrates 62c, 63c, and 64c included in the control apparatus 50 for controlling in-vehicle devices.

### Embodiment 2

The deterioration determination device may be implemented in a manner other than the above-described exemplary manner. A deterioration determination device 1 according to Embodiment 2 has the configuration similar to that of the deterioration determination device 1 according to Embodiment 1. Unlike Embodiment 1, each of the substrates 61c, 62c, 63c, and 64c is provided with a control circuit for controlling in-vehicle devices in the control apparatus 50 to be subject to the determination by the deterioration determination device 1. The deterioration determination device 1 in Embodiment 2 is mounted on the substrate 61c provided with the control circuit for controlling in-vehicle devices.

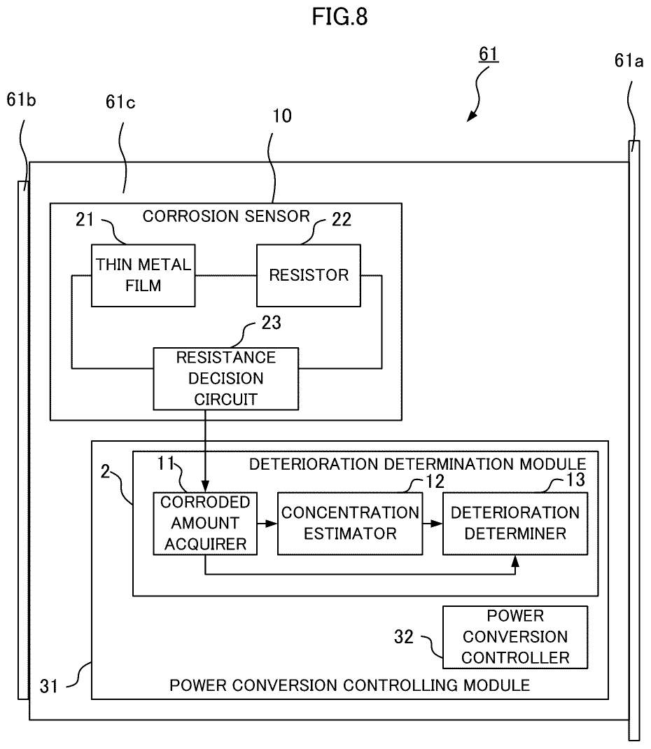

As illustrated in FIG. 8, the substrate 61c is provided with the corrosion sensor 10. The substrate 61c is also provided with a power conversion controlling module 31 for controlling the power conversion apparatus installed in a railway vehicle. The power conversion controlling module 31 has a functional component corresponding to the deterioration determination module 2 that performs the functions of the deterioration determination device 1.

The operations of the deterioration determination device 1 according to Embodiment 2 are similar to those in Embodiment 1. The deterioration determination device 1 determines, as well as the determination for the substrate 61c provided with the deterioration determination device 1, whether any sign of deterioration exists in the substrates 62c, 63c, and 64c included in the same control apparatus 50, on the basis of the length of the estimation period and the concentration of the corrosive gas. The thickness of the thin metal film 21 is defined to be smaller than the thickness of the metal material forming the wiring patterns of a power conversion controller 32 provided on the substrate 61c, for example.

As described above, the deterioration determination device 1 according to Embodiment 2 is mounted on the substrate 61c provided with the control circuit for controlling in-vehicle devices. The deterioration determination device 1, mounted on such an existing substrate, can determine whether any sign of deterioration exists in the substrates 61c, 62c, 63c, and 64c, regardless of the limited number of slots of the control apparatus 50.

The above-described embodiments are not to be construed as limiting the scope of the present disclosure. The above-described hardware configuration and flowchart are mere examples and may be arbitrarily varied and modified.

Although the concentration estimator 12 preliminarily retains the relationship between the concentration of the corrosive gas and the change over time in the thickness of the metal material forming the thin metal film 21 illustrated in FIG. 6 in the above-described examples, the relationship between the concentration of the corrosive gas and the change over time in the thickness of the metal material forming the thin metal film 21 may be expressed in a manner other than that in the above-described examples. For example, the concentration estimator 12 may retain a math formula expressing the relationship between the concentration of the corrosive gas and the change over time in the thickness of the metal material constituting the thin metal film 21 preliminarily obtained through examinations or simulations of exposure of the metal material to the corrosive gas, for example.

For another example, the concentration estimator 12 may retain a concentration estimation model established by learning the original thicknesses of the metal material, concentrations of the corrosive gas, and exposure periods. The exposure periods each indicate a period from the time of start of exposure of the metal material to the corrosive gas to the time when the reduction in the thickness of the metal material reaches the original thickness of the metal material. The concentration estimation model is any model that outputs a concentration of the corrosive gas in response to input of a reduction in the thickness of the metal material within the estimation period and a length of the estimation period.

For another example, the concentration estimator 12 may acquire a model that outputs a concentration of a corrosive gas obtained through regression analysis, in response to input of a reduction in the thickness of the metal material within the estimation period and a length of the estimation period. The regression analysis uses the concentration of the corrosive gas as the objective function, with the reduction in the thickness of the metal member within the estimation period and the length of the estimation period as independent variables.

The deterioration determination device 1 may also be implemented as a function of a train information management system. The deterioration determination device 1 may be installed in not the railway vehicle but a control center, for example.

The central part that includes the processor 91, the memory 92, and the interface 93 and executes the control process can be achieved by not only dedicated systems but also ordinary computer systems. For example, a computer program for executing the above-described operations may be stored in computer-readable recording mediums, such as flexible disks, compact disc read-only memories (CD-ROMs), and digital versatile disc read-only memories (DVD-ROMs), and distributed. The computer program may then be installed in a computer, so as to implement the deterioration determination device 1 for executing the operations. Alternatively, the computer program may be stored in a storage device included in a server on a communication network, and may be downloaded into an ordinary computer system to implement the deterioration determination device 1.

In the case where an operating system (OS) and an application program share with each other in implementing the functions of the deterioration determination device 1 or the functions of the deterioration determination device 1 are achieved by cooperation of the OS and the application program, only the application program may be stored in a non-transitory recording medium or a storage device.

The computer program may be distributed via a communication network in the form of being superimposed on carrier waves. For example, the computer program may be posted on a bulletin board system (BBS) on a communication network and may be distributed to computers via the communication network. The computers may activate this computer program and execute the computer program under the control of the OS in the same manner as the other application programs, and thereby execute the above-described operations.

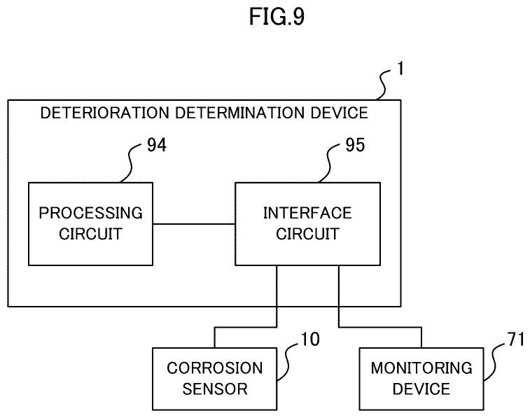

The deterioration determination device 1 may be achieved by a processing circuit 94, as illustrated in FIG. 9. The processing circuit 94 is connected to the corrosion sensor 10 and the monitoring device 71 via an interface circuit 95. In the case where the processing circuit 94 is dedicated hardware, the processing circuit 94 is a single circuit, a combined circuit, a programmed processor, a parallel programmed processor, an application specific integrated circuit (ASIC), a field programmable gate array (FPGA), or a combination thereof, for example. The components of the deterioration determination device 1 may be implemented using separate processing circuits 94 or a shared processing circuit 94.

Some of the functions of the deterioration determination device 1 may be implemented by dedicated hardware, and other functions may be implemented by software or firmware. For example, the corroded amount acquirer 11 may be implemented using the processing circuit 94 illustrated in FIG. 9, and the concentration estimator 12 and the deterioration determiner 13 may be implemented by the processor 91 illustrated in FIG. 4 reading and executing programs stored in the memory 92.

The length of the estimation period may be determined in a procedure other than that in the above-described examples. For example, the estimation period does not necessarily start from the time of reception of the operation start signal by the corroded amount acquirer 11, and may start from the time of start of commercial operation of the railway vehicle in response to an initial activation signal, or the time of start of running of the railway vehicle after completion of test runs, for example.

For another example, the length of the estimation period may be calculated by multiplying the number of executions of the process of determining a sign of deterioration illustrated in FIG. 5 by the deterioration determination device 1 since the start of operation of the railway vehicle, by the cycle of repetition of the process illustrated in FIG. 5. For another example, the corroded amount acquirer 11 may acquire time information from an external apparatus, and determine a length of the estimation period by calculating the difference between the time of reception of an operation start signal and the time of calculation of the estimation period.

The control apparatus 50 is not necessarily a subrack apparatus, and may be any electronic apparatus containing a metal material that can be corroded due to exposure to a corrosive gas. For example, the control apparatus 50 may be installed in the cab.

The deterioration determination device 1 may output a result of determination to any output device, other than the monitoring device 71. For example, the deterioration determination device 1 may output a result of determination to an LED device disposed on the front panel 61a of the substrate 61c. The LED device may be lighted for the result of determination indicating the presence of any sign of deterioration, and be turned off for the result of determination indicating the absence of any sign of deterioration.

The corroded amount acquirer 11 may acquire a reduction in the thickness of the thin metal film 21 due to corrosion before occurrence of breakage of the thin metal film 21 due to corrosion, on the basis of a preliminarily retained relationship between the combined resistance and the thickness of the thin metal film 21, and the combined resistance acquired from the corrosion sensor 10, because the resistance of a metal material varies depending on the cross-sectional area of the metal material. The concentration estimator 12 in this modification can estimate a concentration of the corrosive gas, on the basis of the reduction in the thickness of the thin metal film 21 due to corrosion acquired by the corroded amount acquirer 11, and the length of the estimation period.

The metal material forming the wiring patterns is not necessarily silver and may be a metal, such as copper, iron, tin, zinc, aluminum, or nickel, susceptible to corrosion due to exposure to a corrosive gas.

The deterioration determination device 1 does not necessarily estimate a concentration of hydrogen sulfide, and may estimate a concentration of any corrosive gas, such as sulfur dioxide, nitrogen oxides, chlorine, or ammonia, capable of corroding metals.

The deterioration determiner 13 may preliminarily retain, for each combination of multiple types of metal materials and multiple types of corrosive gases, a relationship between the concentration of the corrosive gas and the change over time in the thickness of the metal material forming the thin metal film 21. The deterioration determiner 13 can thus determine whether any sign of deterioration exists in the substrates 61c, 62c, 63c, and 64c, on the basis of the concentrations of multiple types of corrosive gases.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### Reference Signs List

1 Deterioration determination device
2 Deterioration determination module
10 Corrosion sensor
11 Corroded amount acquirer
12 Concentration estimator
13 Deterioration determiner
21 Thin metal film
22 Resistor
23 Resistance decision circuit
31 Power conversion controlling module
32 Power conversion controller
50 Control apparatus
51 Subrack
52 Backplane
53, 54, 55, 56 Slot
61, 62, 63, 64 Plug-in unit
61a, 62a, 63a, 64a Front panel
61b, 62b, 63b, 64b Connector
61c, 62c, 63c, 64c Substrate
71 Monitoring device
72 Display screen
73 Button
90 Bus
91 Processor
92 Memory
93 Interface
94 Processing circuit
95 Interface circuit

1. A deterioration determination device, comprising:
corroded amount acquiring circuitry to acquire a reduction in a thickness of a thin metal film within an estimation period from a time of start of operation of a railway vehicle, the thin metal film being mounted on any of substrates included in an electronic apparatus installed in the railway vehicle, the thin metal film being made of a metal material corroded due to exposure to a corrosive gas;
concentration estimating circuitry to estimate, based on the reduction in the thickness of the thin metal film within the estimation period acquired by the corroded amount acquiring circuitry and a relationship between a concentration of the corrosive gas and a change over time in a thickness of the metal material, a concentration of the corrosive gas; and
deterioration determining circuitry to determine, based on a length of the estimation period and the concentration of the corrosive gas estimated by the concentration estimating circuitry, whether any sign of deterioration exists in the substrates included in the electronic apparatus.

2. The deterioration determination device according to claim 1, wherein
the electronic apparatus is a control apparatus for controlling in-vehicle devices installed in the railway vehicle, and
the corroded amount acquiring circuitry acquires a reduction in a thickness of a thin metal film, the thin metal film being mounted on one of the substrates included in the electronic apparatus, the substrate being provided with a control circuit for controlling the in-vehicle devices, the thin metal film having an original thickness smaller than an original thickness of the metal material forming wiring patterns mounted on the substrate provided with the control circuit.

3. The deterioration determination device according to claim 1, wherein
the electronic apparatus is a control apparatus for controlling in-vehicle devices installed in the railway vehicle, and
the corroded amount acquiring circuitry acquires a reduction in a thickness of a thin metal film, the thin metal film being mounted on one of the substrates included in the electronic apparatus, the substrate being different from another substrate provided with a control circuit for controlling the in-vehicle devices, the thin metal film having an original thickness smaller than an original thickness of the metal material forming wiring patterns mounted on the other substrate provided with the control circuit.

4. The deterioration determination device according to claim 1, wherein the corroded amount acquiring circuitry
acquires an operation start signal for instructing the railway vehicle to start operation, and
acquires a reduction in the thickness of the thin metal film within the estimation period from a time of output of the operation start signal to instruct the railway vehicle to start operation.

5. The deterioration determination device according to claim 1, wherein the corroded amount acquiring circuitry acquires, based on a combined resistance of the thin metal film and a resistor provided from a corrosion sensor, a reduction in the thickness of the thin metal film within the estimation period, the corrosion sensor being configured to measure the combined resistance, the resistor being connected in series to the thin metal film and more resistant to the corrosive gas than the thin metal film.

6-10. (canceled)

11. The deterioration determination device according to claim 2, wherein the corroded amount acquiring circuitry acquires, based on a combined resistance of the thin metal film and a resistor provided from a corrosion sensor, a reduction in the thickness of the thin metal film within the estimation period, the corrosion sensor being configured to measure the combined resistance, the resistor being connected in series to the thin metal film and more resistant to the corrosive gas than the thin metal film.

12. The deterioration determination device according to claim 3, wherein the corroded amount acquiring circuitry acquires, based on a combined resistance of the thin metal film and a resistor provided from a corrosion sensor, a reduction in the thickness of the thin metal film within the estimation period, the corrosion sensor being configured to measure the combined resistance, the resistor being connected in series to the thin metal film and more resistant to the corrosive gas than the thin metal film.

13. The deterioration determination device according to claim 1, wherein the concentration estimating circuitry estimates a concentration of the corrosive gas, based on the length of the estimation period, an original thickness of the thin metal film, and the relationship between the concentration of the corrosive gas and the change over time in the thickness of the metal material, when the reduction in the thickness of the thin metal film within the estimation period acquired by the corroded amount acquiring circuitry is equal to the original thickness of the thin metal film.

14. The deterioration determination device according to claim 2, wherein the concentration estimating circuitry estimates a concentration of the corrosive gas, based on the length of the estimation period, an original thickness of the thin metal film, and the relationship between the concentration of the corrosive gas and the change over time in the thickness of the metal material, when the reduction in the thickness of the thin metal film within the estimation period acquired by the corroded amount acquiring circuitry is equal to the original thickness of the thin metal film.

15. The deterioration determination device according to claim 3, wherein the concentration estimating circuitry estimates a concentration of the corrosive gas, based on the length of the estimation period, an original thickness of the thin metal film, and the relationship between the concentration of the corrosive gas and the change over time in the thickness of the metal material, when the reduction in the thickness of the thin metal film within the estimation period acquired by the corroded amount acquiring circuitry is equal to the original thickness of the thin metal film.

16. The deterioration determination device according to claim 1, wherein the deterioration determining circuitry determines that deterioration occurs in the substrates when the concentration of the corrosive gas estimated by the concentration estimating circuitry is equal to or higher than a concentration threshold and when the length of the estimation period is equal to or longer than a period threshold, the concentration threshold being defined in accordance with a thickness of the metal material forming wiring patterns mounted on the substrate and the relationship between the concentration of the corrosive gas and the change over time in the thickness of the metal material, the period threshold varying depending on the concentration of the corrosive gas and being defined in accordance with a rate of corrosion of the metal material exposed to the corrosive gas.

17. The deterioration determination device according to claim 2, wherein the deterioration determining circuitry determines that deterioration occurs in the substrates when the concentration of the corrosive gas estimated by the concentration estimating circuitry is equal to or higher than a concentration threshold and when the length of the estimation period is equal to or longer than a period threshold, the concentration threshold being defined in accordance with a thickness of the metal material forming wiring patterns mounted on the substrate and the relationship between the concentration of the corrosive gas and the change over time in the thickness of the metal material, the period threshold varying depending on the concentration of the corrosive gas and being defined in accordance with a rate of corrosion of the metal material exposed to the corrosive gas.

18. The deterioration determination device according to claim 3, wherein the deterioration determining circuitry determines that deterioration occurs in the substrates when the concentration of the corrosive gas estimated by the concentration estimating circuitry is equal to or higher than a concentration threshold and when the length of the estimation period is equal to or longer than a period threshold, the concentration threshold being defined in accordance with a thickness of the metal material forming wiring patterns mounted on the substrate and the relationship between the concentration of the corrosive gas and the change over time in the thickness of the metal material, the period threshold varying depending on the concentration of the corrosive gas and being defined in accordance with a rate of corrosion of the metal material exposed to the corrosive gas.

19. The deterioration determination device according to claim 1, wherein
the electronic apparatus is a subrack apparatus including a back plane having slots and a subrack for accommodating the back plane, and
the corroded amount acquiring circuitry
is accommodated in the electronic apparatus, and
acquires a reduction in a thickness of a thin metal film within the estimation period, the thin metal film being mounted on a substrate of a plug-in unit to be connected to one of the slots, the slot being located at an end in an arrangement direction of the slots.

20. The deterioration determination device according to claim 2, wherein
the electronic apparatus is a subrack apparatus including a back plane having slots and a subrack for accommodating the back plane, and
the corroded amount acquiring circuitry
is accommodated in the electronic apparatus, and
acquires a reduction in a thickness of a thin metal film within the estimation period, the thin metal film being mounted on a substrate of a plug-in unit to be connected to one of the slots, the slot being located at an end in an arrangement direction of the slots.

21. The deterioration determination device according to claim 3, wherein
the electronic apparatus is a subrack apparatus including a back plane having slots and a subrack for accommodating the back plane, and
the corroded amount acquiring circuitry
is accommodated in the electronic apparatus, and
acquires a reduction in a thickness of a thin metal film within the estimation period, the thin metal film being mounted on a substrate of a plug-in unit to be connected to one of the slots, the slot being located at an end in an arrangement direction of the slots.

22. The deterioration determination device according to claim 1, wherein the deterioration determining circuitry outputs, to a monitoring device installed in the railway vehicle, a result of determination indicating existence of a sign of deterioration in the substrates.

23. A deterioration determination method comprising:
acquiring a reduction in a thickness of a thin metal film within an estimation period from a time of start of operation of a railway vehicle, the thin metal film being mounted on any of substrates included in an electronic apparatus installed in the railway vehicle, the thin metal film being made of a metal material corroded due to exposure to a corrosive gas;
estimating, based on the acquired reduction in the thickness of the thin metal film within the estimation period and a relationship between a concentration of the corrosive gas and a change over time in a thickness of the metal material, a concentration of the corrosive gas; and
determining, based on a length of the estimation period and the estimated concentration of the corrosive gas, whether any sign of deterioration exists in the substrates included in the electronic apparatus.
